(19) United States
(12) Patent Application Publication
(10) Pub. No.: US 2009/0231235 A1
(43) Pub. Date: Sep. 17, 2009

(54) PLASMA DISPLAY MODULE

(76) Inventors: Akira Otsuka, Miyazaki (JP); Takashi Sasaki, Miyazaki (JP); Akihiro Takagi, Miyazaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/720,946

(22) PCT Filed: Jun. 20, 2005
(86) PCT No.: PCT/JP05/11270

§ 371 Date: Jun. 6, 2007

(51) Int. Cl. G09G 3/28

(52) U.S. Cl. 345/60

(57) ABSTRACT

In a plasma display module, the cost and size of a power supply circuit are reduced. A plasma display module comprising a plasma display panel (1) having an address electrode, which selects the address of a display pixel, a Y-electrode, which selects a display pixel, and an X-electrode which applies the sustain discharge voltage of a selected pixel; an address electrode drive circuit (4); a Y-electrode drive circuit (2); an X-electrode drive circuit (3); a control circuit (5); and a power supply circuit (6); wherein the power supply circuit (6) includes, between a discharge sustain voltage line (Vs) and a ground (G), an electric field capacitor (61) and an electric double-layer capacitor (62) the capacitance of which can accumulate a charge that is 20 or more times the discharge current of one frame, and wherein each of the Y-electrode and X-electrode drive circuits (2,3) includes, between the discharge sustain voltage line (Vs) and the ground (G), a film capacitor (Cf), a ceramic capacitor (not shown) and/or an electric field capacitor (Cd) used for flowing a high frequency current.

### TECHNICAL FIELD

The present invention relates to a plasma display module, and in particular, to a power supply for display.

### BACKGROUND ART

A plasma display is a large-size/high-capacity flat-type display, and its market is expanding as a flat screen TV for home use. It is required to have the same level of power consumption, display quality and cost as a CRT.

The plasma display is a pulse-driven device through which a large spike-like current passes for display discharge in particular. To stably perform display and keep predetermined display luminance, it is necessary to stabilize a power supply voltage, and a power supply requires a high-power element for passing a peak current. As a large spike-like current passes through the plasma display, noise is apt to be generated from a transformer and the like.

A configuration and a control method of a conventional AC-driven plasma display module will be described by using FIGS. 6 to 9. A basic configuration of the plasma display module will be described by using FIG. 6. The plasma display module includes a plasma display panel 1, an X electrode drive (X sustain: X electrode sustain discharge) circuit 3, a Y electrode drive (Y scan) circuit 2, an address electrode drive circuit (address driver) 4, a control circuit 5 and a power supply 6.

The plasma display panel 1 includes a Y electrode (scan electrode: Y bus) Yi where writing of each pixel is controlled by the Y electrode drive circuit 2, an X electrode (sustain discharge electrode: X bus) Xi where a sustain discharge voltage is applied to each pixel by the X electrode drive circuit 3, and an address electrode Aj where an address of each pixel is controlled by the address electrode drive circuit 4.

The Y electrode drive circuit (scan driver) 2 supplies a predetermined voltage to scan electrodes Y1, Y2, Y3 and so on according to control of the control circuit 5. Hereunder, the scan electrodes Y1, Y2, Y3 and so on are respectively or generically named scan electrodes Yi, where i means a suffix.

The X electrode drive circuit (sustain discharge electrode sustain circuit) 3 supplies the same voltage to sustain discharge electrodes X1, X2, X3 and so on respectively. Hereunder, the sustain discharge electrodes X1, X2, X3 and so on are respectively or generically named sustain discharge electrodes Xi, where means a suffix. The sustain discharge electrodes Xi are mutually connected, and have the same voltage level.

The address electrode drive circuit 4 supplies a predetermined voltage to address electrodes A1, A2, A3 and so on. Hereunder, the address electrodes A1, A2, A3 and so on are respectively or generically named address electrodes Aj, where j means a suffix.

The control circuit 5 controls the Y electrode drive circuit 2, the X electrode drive circuit 3 and the address electrode drive circuit 4.

The power supply 6 is a circuit for applying a drive voltage to the control circuit 5, the X electrode drive circuit 3, the Y electrode drive circuit 2 and the address electrode drive circuit 4.

In a display area which is set in a PDP panel 1, the scan electrodes Yi and the sustain discharge electrodes Xi form lines extending in parallel in a horizontal direction, and the address electrodes Aj form rows extending in a vertical direction. The scan electrodes Yi and sustain discharge electrodes Xi are alternately placed in the vertical direction. A stripe rib structure is provided between the address electrodes Aj.

The scan electrodes Yi and the address electrodes Aj form a two-dimensional matrix of i lines and j rows. A display cell Cij is formed by an intersection of the scan electrodes Yi with the address electrodes Aj and the sustain discharge electrode Xi correspondingly adjacent thereto. These cells Cij can display a two-dimensional image in the display area correspondingly to pixels.

FIG. 7 (A) is a diagram showing a cross-sectional configuration of a surface of the display cell Cij parallel with an extension direction of the address electrode Aj. The sustain discharge electrode Xi and the scan electrode Yi are formed on a front glass plate 12. A dielectric layer 15 for insulating them from a discharge space 13 is deposited thereon, and an MgO (magnesium oxide) protection film 16 is further deposited thereon.

The address electrode Aj is formed on a rear glass plate 11 placed opposite the front glass plate 12. A dielectric layer 14 is deposited thereon, and a phosphor is further deposited thereon.

An Ne+Xe gas or the like is contained in the discharge space 13 between the MgO protection film 16 and the dielectric layer 14.

FIG. 7 (B) is a diagram for describing a capacity Cp of an AC-driven plasma display. A capacity Ca is a capacity of the discharge space 13 between the sustain discharge electrode Xi and the scan electrode Yi. A capacity Cb is a capacity of the dielectric layer 15 between the sustain discharge electrode Xi and the scan electrode Yi. A capacity Cc is a capacity of the front glass plate 12 between the sustain discharge electrode Xi and the scan electrode Yi. The capacity Cp between the electrodes Xi and Yi is decided by a total of the capacities Ca, Cb and Cc.

FIG. 7 (C) is a sectional view of a surface orthogonal to the extension direction of the address electrode Aj for describing emission of the AC-driven plasma display. On an inner surface of a rib 17, phosphors 18 in red, blue and green are arranged and applied by color in a stripe state. The phosphors 18 are excited by a discharge for pixel display between the sustain discharge electrode Xi and the scan electrode Yi (discharging electrode pair) so as to generate a light 19.

FIG. 8 is a block diagram of one frame FR of an image. The image is formed at 60 frames/second for instance. One frame FR is formed by a first subframe SF1, a second subframe SF2 and up to an n-th subframe SFn. The n is 10 for instance, which depends on the number of gradation bits. Hereunder, the subframes SF1, SF2 and so on are respectively or generically named subframes SF.

Each of the subframes SF is composed of a reset period Tr, an address period Ta and a sustain period (sustain discharge period) Ts. In the reset period Tr, the display cells are initialized. In the address period Ta, it is possible to select lighting or non-lighting of each display cell by addressing. A selected cell emits light in the sustain period Ts. The number of times of emission (number of sustain pulses) is different according to brightness of the emission in the sustain period Ts of each subframe SF. Luminance of the pixel is decided by the total of the number of times of emission in one frame FR.

FIG. 9 is a waveform diagram of the subframes SF shown in FIG. 8. FIG. 9 shows waveform examples of the voltages applied to the X electrode, Y electrode and address electrode of one subframe out of multiple subframes constituting one frame. One subframe is separated into the reset period Tr composed of an entire-surface writing period and an entire-surface erasure period, the address period Ta and the sustain period Ts.

In the sustain period Ts, voltages of mutually different polarities (+Vs/2, −Vs/2) are alternately applied to the sustain discharge electrode X and the scan electrode Y of each display line so as to perform the sustain discharge and display video of one subframe. The operation of alternate application is called a sustain operation. According to the sustain operation, upon the discharge, charges of different polarities are accumulated on the sustain discharge electrode X and the scan electrode Y. If a next sustain discharge voltage is applied, the discharge is started at a voltage equal to or lower than the voltage at the start of discharge due to influence of the accumulated charges so that charges of a reverse polarity are accumulated on each of the electrodes. This discharge is a discharge in which a large current passes in a very short time.

The above-mentioned configuration and control method of the plasma display module is already known (refer to Patent Document 1 for instance).

Patent Document 1: Japanese Patent Laid-Open Publication No. 5-265397

As described above, most of the power consumption of the conventional plasma display is gas discharge power for display, where a spike-like discharge current passes due to application of a high-frequency discharge sustain pulse of 100 kHz or so for the sake of the sustain discharge. While rewriting of 50 frames or 60 frames per second is generally performed for movie display, the display is performed by rewriting subframes in the cases such as performing multiple tone display by an ADS subframe method. In the case of an AC-type plasma display, the luminance is approximately proportional to the number of discharge sustain pulses. When sustain pulse frequencies are the same, the periods when a high-frequency spike-like discharge current passes of the subframes are different, such as 1, 2, 4, 8, 16 and 32.

Each of the subframes is composed of the periods, such as reset, address and display. Normally, the reset, address and the like require ¾ or so of a display period, and the time period when a display discharge is performed is as small as ¼ of the entire time period. The discharge current corresponding to a single-shot sustain pulse normally has a width of 1 μs or less and a cycle of 5 μs or so. Therefore, the current passing in a single-shot discharge can normally be supplied from a capacitor 61 such as an electrolytic capacitor or a film capacitor of the power supply 6. As the voltage of the capacitor is reduced when the number of times of discharge increases, it is necessary to supply from the power supply 6, that is, a large-current rectification/smoothing circuit in the case where the discharge continues. The discharge period is approximately ¼ of the entire time period so that it requires a large-size power source capable of supplying the current four times that of average power. Thus, there was a problem that the cost is high, and the size and weight become significant. It also has a problem that noise is apt to be generated from the transformer and the like because the large spike-like current passes.

An object of the present invention is to provide a display device of a plasma display module wherein a power supply is rendered low-cost and small-size. Another object of the present invention is to provide a power supply wherein no noise is generated.

### DISCLOSURE OF THE INVENTION

To solve the problems, the present invention provides a plasma display module including: a plasma display panel including an address electrode for selecting an address of a display pixel, a Y electrode for selecting the display pixel and an X electrode for applying a sustain discharge voltage of the selected pixel; an address electrode drive circuit; a Y electrode drive circuit; an X electrode drive circuit; a control circuit; and a power supply, wherein the electrode circuits are provided with a capacitor of a capacity capable of accumulating charges 20 times or more a discharge current of one frame between a discharge sustain voltage line and a ground.

Furthermore, the present invention provides the plasma display module, wherein: the capacitor is an electric double layer capacitor; and an electrolytic capacitor and/or a ceramic capacitor and/or a film capacitor for passing a high-frequency current to a plasma display drive circuit or a power supply are provided between the discharge sustain voltage line and the ground.

To be more specific, the plasma display panel or the plasma display module has instantaneous power fluctuation within one frame. However, if the peak current/power within one frame can be stored in the capacitor or the like, a power supply of average current/power should be sufficient. In the case of the plasma display, the peak power of the power source is as large as four times the average power. Therefore, if a capacitor capable of sustaining the power supply voltage to the degree of not influencing the discharge operation and luminance during one frame is provided in parallel with the power source, the power supply has only to supply the average power so that it can be miniaturized to approximately ¼. Therefore, the current passing through the transformer constituting the power supply becomes almost constant so that noise generation from the transformer and the like can be prevented.

According to the present invention, the power supply supporting average power of approximately ¼ is sufficient instead of a high-power power supply supporting the peak current within one frame. Therefore, the power supply can be rendered low-cost and small-size, and no noise is generated. It is also possible to reduce instantaneous voltage fluctuation of the applied voltage so as to perform stable display.

### BRIEF DESCRIPTION OF THE DRAWINGS

FIG. 1 is a diagram for describing an overview of a configuration of a plasma display module according to the present invention;

FIG. 2 is a diagram for describing the configuration of one display frame of the plasma display module according to the present invention;

FIG. 3 is a diagram schematically showing a relation between a voltage and a discharge current applied to an X electrode drive circuit and a Y electrode drive circuit in the frame shown in FIG. 2;

FIG. 4 is a diagram for describing the relation between the discharge current and a power supply current in one frame of the plasma display module according to the present invention;

FIG. 5 is a diagram for describing an operation margin of an AC-type PDP;

FIG. 6 is a diagram for describing an overview of the configuration of a conventional plasma display module;

FIG. 7 (A) is a longitudinal section of a surface parallel with an extension direction of an address electrode for describing a structure of a plasma display panel;

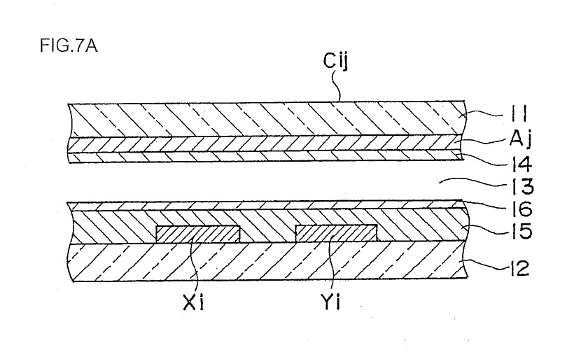

FIG. 7 (B) is a diagram for describing generation of a capacitor of the plasma display panel;

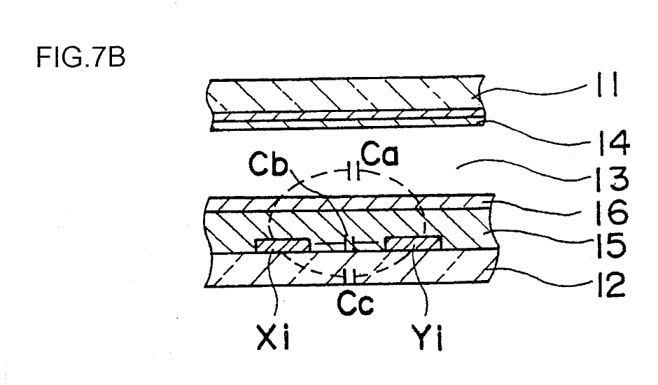

FIG. 7 (C) is a longitudinal section of a surface orthogonal to the extension direction of the address electrode for describing the structure of the plasma display panel;

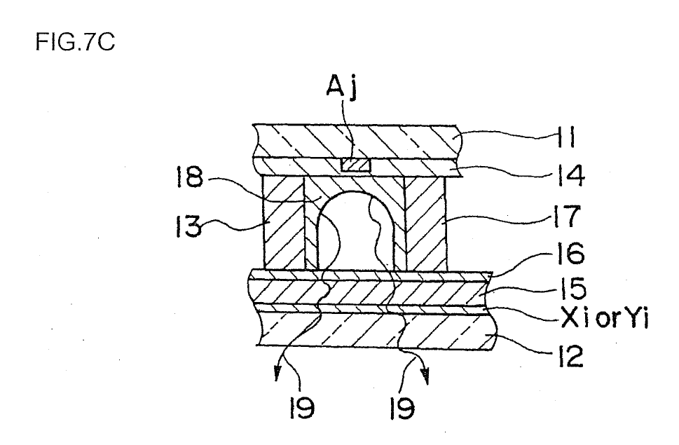

FIG. 8 is a waveform diagram showing an example of a sustain discharge current form of the present invention; and

FIG. 9 is a diagram for describing an overview of the applied voltages of the plasma display module.

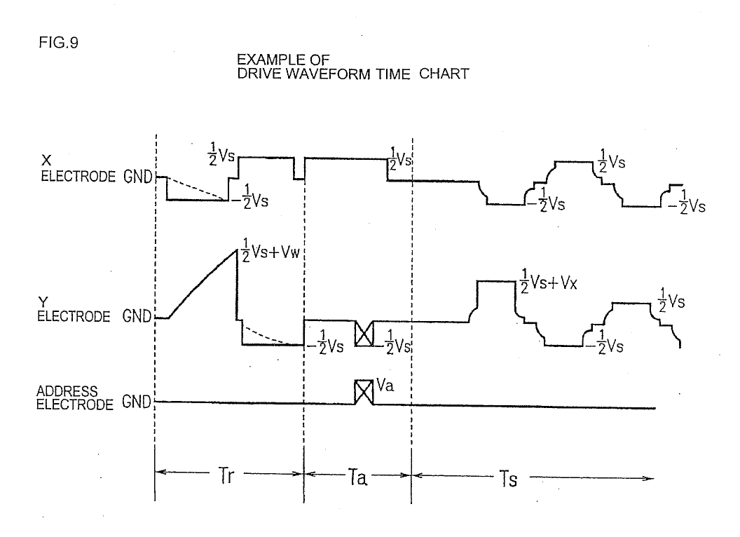

### DESCRIPTION OF SYMBOLS

1: Plasma display panel
2: Y electrode drive circuit
3: X electrode drive circuit
4: Address electrode drive circuit
5: Control circuit
6: Power supply
61: Electrolytic capacitor
62: Electric double layer capacitor
A: Address electrode
X: X electrode (sustain discharge electrode)
Y: Y electrode (scan electrode)

### BEST MODE FOR CARRYING OUT THE INVENTION

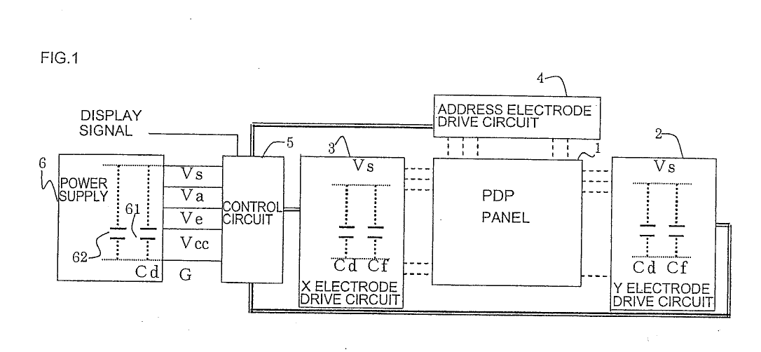

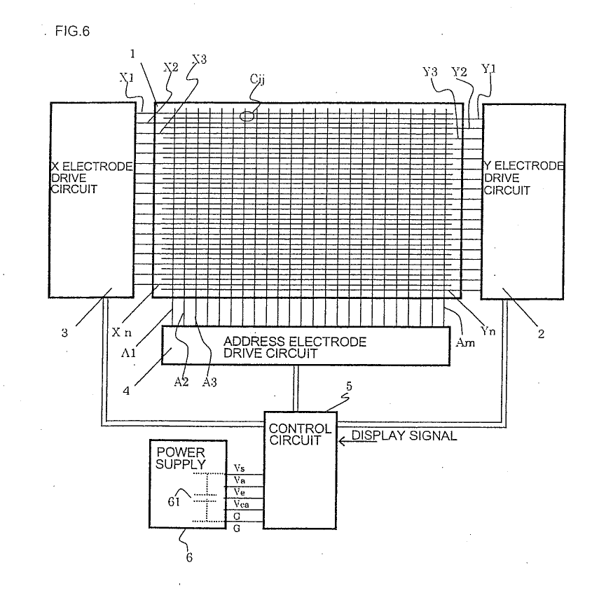

A configuration and a control method of a plasma display module according to the present invention will be described by using FIG. 1. The plasma display module according to the present invention has approximately the same configuration as the plasma display module shown in FIG. 6. To be more specific, the plasma display module according to the present invention is configured by including a plasma display panel 1, a Y electrode drive circuit 2, an X electrode drive circuit 3, an address electrode drive circuit 4, a control circuit 5 and a power supply 6.

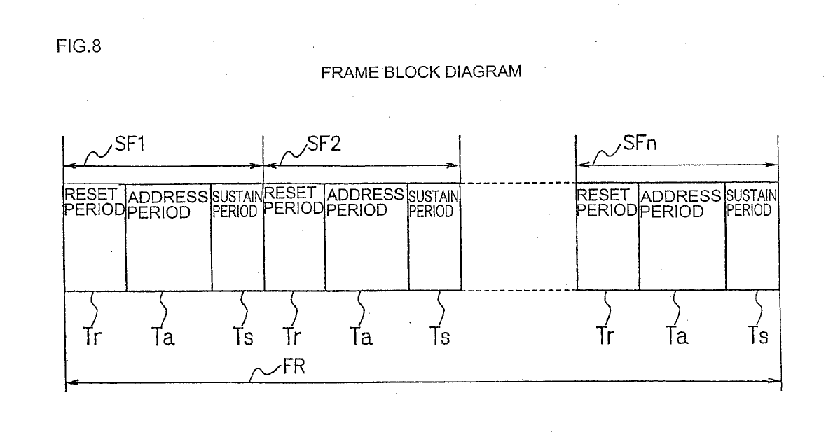

The Y electrode drive circuit 2 and the X electrode drive circuit 3 can generate a sustain discharge pulse of a sustain period Ts shown in FIG. 8.

According to the present invention, the Y electrode drive circuit 2 and the X electrode drive circuit 3 have multiple electrolytic capacitors Cd and/or film capacitors Cf and/or ceramic capacitors Cc not shown and the like placed in combination therein so as to pass a large-current pulse by applying a sustain discharge voltage pulse at high speed. According to the present invention, the power supply 6 is connected with an electric double layer capacitor 62 in parallel with the electrolytic capacitor Cd 61, and is also connected with a sustain discharge voltage Vs output in parallel.

A current flowing from a sustain pulse generating circuit of the Y electrode drive circuit 2 is mainly a discharge current generated immediately after application of each sustain pulse, where a pulse current of which width is 0.3 μs or so flows. If the pulse current is passed from the power supply 6, a voltage effect is generated by wiring impedance so that the electrolytic capacitors Cd, film capacitors Cf, ceramic capacitors Cc and the like are placed near a sustain voltage pulse generating circuit of the Y electrode drive circuit 2.

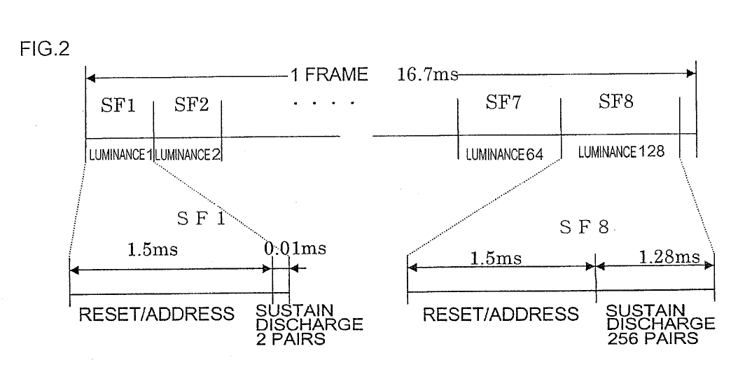

A principle of luminance representation of each individual pixel will be described by using FIG. 2. In the case of displaying gradation by using 8 bits for instance, one frame of 16.7 ms is divided into eight subframes SF1 to SF8, where each of the subframes SF is composed of a reset period and an address period of 1.5 ms and a sustain discharge period. The luminance is decided by the number of discharge pairs in the sustain discharge period. For instance, luminance 1 is represented by a sustain discharge of two pairs in a sustain discharge period (0.01 ms) in SF1, and luminance 128 is represented by a sustain discharge of 256 pairs in a sustain discharge period (1.28 ms) in SF8.

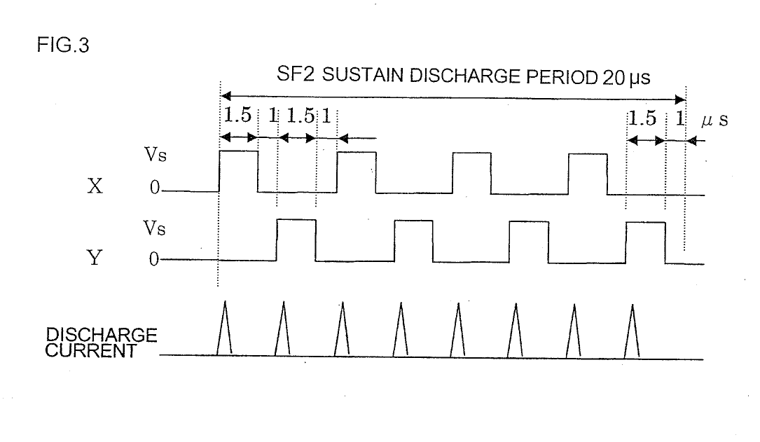

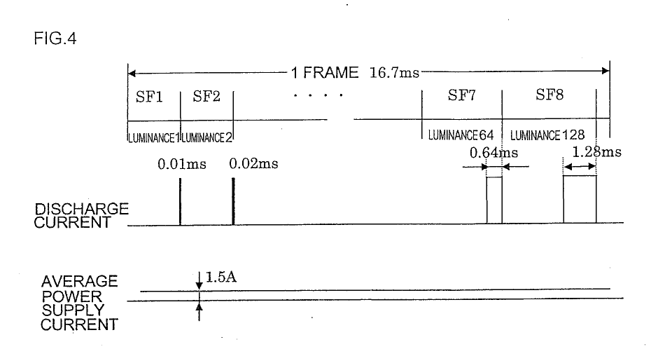

A sustain discharge pulse current and a current waveform flowing from the power supply 6 will be described by using FIGS. 3 and 4. In an example of a 42-type panel, the peak current per line of the sustain discharge pulse is approximately 200 mA, and a power supply voltage in the sustain discharge period is 6 A or so. While an average current of one frame is approximately 1.5 A (165 V×1.5 A=approximately 250 W), a total capacitor capacity of the capacitors Cd provided in the power source is normally 1,000° F. or so. Thus, the current within one frame cannot be accumulated, and so a current capacity of a transformer, a rectifying element and the like is designed as 6 A or more. Therefore, the current capacity four times average power is required. If a large spike-like current passes, noise is apt to be generated from the transformer. The noise is normally reduced by impregnating the transformer with an insulating resin. As for TV use, noise generation is a big problem because it is appreciated in a quiet environment.

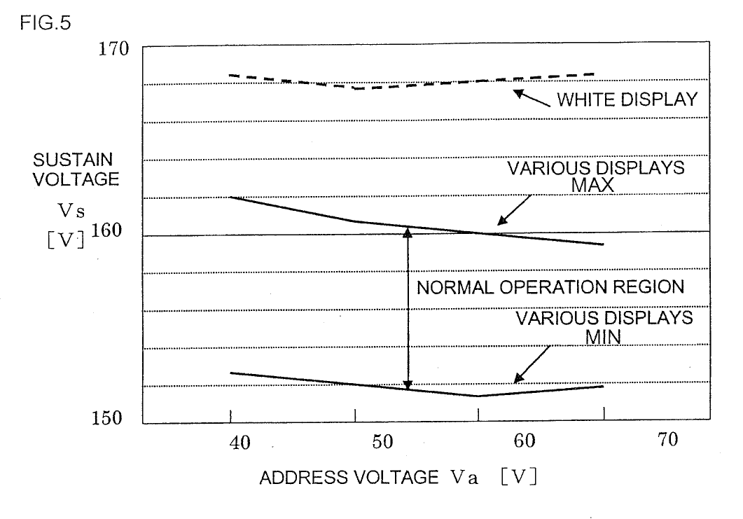

FIG. 5 shows display properties in the case of changing the sustain voltage Vs and an address voltage Va of the display panel. This example shows that a normally displayable sustain voltage range (voltage margin) is approximately 8 V, and it normally displays if fluctuation of the voltage Vs is 5% or less. However, it is normally desirable to set the fluctuation of the voltage at 2% or less in view of temperature fluctuation and temporal fluctuation of a drive voltage.

The electric double layer capacitor (200 V/0.01 F) 62 and the electrolytic capacitor Cd (200 V/270° F.) 61 are connected between an output voltage Vs (approximately 165 V) and a ground G of the power supply 6. And the electrolytic capacitors Cd (200 V/270 μF) and the film capacitors Cf (200 V/2° F.) are connected between a discharge sustain voltage Vs (approximately 160 V) and a ground G of the X electrode drive circuit 3 respectively. As shown in FIG. 3, in this drive circuit, the discharge current corresponding to the sustain discharge pulse is the same as before. And the average current flowing in a discharge sustain period is approximately 6 A while the average current of one frame is approximately 1.5 A. Charges Qo flowing in one frame are 1.5 A×16.7 ms≈25 mΩ. If the current only flows from the electric double layer capacitor 62, the voltage Vs of the capacitor decreases to (Vs˜C−Qo)/C≈0.985 Vs. The fluctuation of the discharge sustain voltage is approximately 1.5%, which is less than 5% and so it is within a stable operation voltage range and the display is normally performed.

The current flowing from the power supply 6 becomes almost constant at approximately 1.5 A as shown in FIG. 4. Thus, the transformer, rectifying element and the like of the power supply should be designed with the current capacity of approximately 1.5 A. The current passing through the power supply such as the transformer is constant, and so there is no generation of noise even though it is not impregnated with the insulating resin.

To realize voltage fluctuation of 2% or less for satisfying long-term stability of the display, (Vs·C−Qo)/Vs·C>0.98, that is, Vs·C>50 Qo should be satisfied. To make the voltage fluctuation 5% or less, Vs·C>20 Qo should be satisfied likewise. To be more specific, it is necessary, for the sake of suppressing the voltage fluctuation, to have a capacitor of a capacity capable of accumulating the charges at least 20 times or preferably times the discharge current of one frame. If the electric double layer capacitor 62 of such a capacity is connected to a sustain voltage power supply, it is possible to perform the normal display with the voltage fluctuation of 2% or less or 5% or less in spite of a small power supply current capacity in the case where an output current from the power supply 6 such as the transformer and the rectifying element changes in one frame or in the case where an output current from the power supply such as the transformer and the rectifying element changes in one frame by connecting to the power supply.

To realize such a large capacity only with the electrolytic capacitor 61, it is necessary to mount the capacitor of an extremely large size or a large number of the capacitors. Therefore, there is no advantage in doing so. If the electric double layer capacitor 62 is used, however, a small-size and high-capacity capacitor can be realized so that a design as with this embodiment becomes possible.

The embodiment only shows a concrete example in implementing the present invention, which should not limit interpretation of the technical range of the present invention. To be more specific, the present invention can be implemented in various forms without departing from technical idea or main characteristics thereof.

1. A plasma display module including: a plasma display panel including an address electrode for selecting an address of a display pixel, a Y electrode for selecting the display pixel and an X electrode for applying a sustain discharge voltage of the selected pixel; an address electrode drive circuit; a Y electrode drive circuit; an X electrode drive circuit; a control circuit; and a power supply, characterized in that the electrode circuits are provided with a capacitor of a capacity capable of accumulating charges at least 20 times a discharge current of one frame.

2. The plasma display module according to claim 1, characterized in that: the capacitor is an electric double layer capacitor; and an electrolytic capacitor and/or a ceramic capacitor and/or a film capacitor for passing a high-frequency current to a plasma display drive circuit or a power supply are/is provided between a high voltage line and a low voltage line of a discharge sustain voltage.
